(19) United States
(12) Patent Application Publication
(10) Pub. No.: US 2024/0126821 A1
(43) Pub. Date: Apr. 18, 2024

(54) SUGGESTIONS OF DIVERSE CONTENT

(71) Applicant: Meta Platforms, Inc., Menlo Parks, CA (US)

(72) Inventors: Han Ren, Los Altos, CA (US); Shruti Bhutada, Santa Clara, CA (US); Jus-Tin Cheng, Sunnyvale, CA (US); Ellen Yutong Lu, San Francisco, CA (US); Rehman Khan, East Windsor, NJ (US); Jonathan Eusung Kim, Santa Clara, CA (US); Shilpa Mody, San Francisco, CA (US); Woo Jung Oh, New York, NY (US); Kyle Yank Zhu, Santa Clara, CA (US); Gargi Apte, San Leandro, CA (US); Moira Kathleen Ballantyne Burke, San Francisco, CA (US)

(21) Appl. No.: 17/967,694

(22) Filed: Oct. 17, 2022

(51) Int. Cl. G06F 16/9535

(52) U.S. Cl. CPC G06F 16/9535

(57) ABSTRACT

Techniques for providing suggested content is described. For example, a social networking system may receive, from an account of a social networking system, an indication of a selection of a first content item. The social networking system may determine that the first content item is associated with a first topic and may receive a request from the account to access a second content item associated with the first topic. The social networking system may then cause presentation of the second content item and may determine that the request meets or exceeds a threshold number of requests for content items associated with the first topic. Based on determining that the request meets or exceeds the threshold, the social networking system may cause presentation of a suggested content item associated with a second topic.

### BACKGROUND

Digital platforms such as text messaging, instant messaging, email, social media, gaming, or other applications by which users can share content provide users with numerous benefits and opportunities. For instance, users may share information, media, and other types of content with family, friends, colleagues, and even strangers. However, the freedom associated with consuming content via these digital platforms is not without problems. For example, users may become focused on a particular type of content which may result in the user being presented with and consuming more and more of the same type of content, potentially at the expense of other types of content in which the user is also interested. Thus, controlling the type and volume of content consumed on digital platforms may present challenges.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a schematic view of an example system usable to implement example techniques described herein.

FIGS. 2A and 2B illustrate example interfaces for generating a suggested content item.

FIGS. 3A-3C illustrate example interfaces including suggested content items.

FIG. 4 illustrates an example interface including content associated with a first topic.

FIG. 5 illustrates an example process for providing accounts with suggested content items.

FIG. 6 illustrates an example process for providing content associated with a suggested content item.

FIG. 7 illustrates an example system and device which may be used to implement the techniques described herein.

### DETAILED DESCRIPTION

As discussed above, controlling how content is presented and viewed on digital platforms presents challenges. For example, digital platforms, such as social networking systems, are often used to create and share content associated with various topics, such as places, activities, and the like. In some examples, this content may be widely shared with other users of the social networking system, allowing users to both share and consume a wide breadth of content. In some cases, social networking systems may attempt to identify content that a user is most interested in, with the goal of providing the user with more content of that type. The social networking system may determine this interest based on content previously viewed by the user, content with which the user has interacted (e.g., commented, liked, shared, clicked-through, etc.), a duration of time that the user engaged with the content, selection by the user of interests from a list of topics, the user's responses to survey questions, or other explicit signals indicating the user's interest in the content. In some examples, the social networking system may also take into account other information, such as age, demographic information, content of interest to social network connections of the user, or other implicit signals that suggest content in which the user may be interested. For example, the social networking system may determine that a user is interested in content associated with traveling. The social networking system may then present the user with more content related to travel, exposing the user to more global destinations to explore.

As long as the user continues to show interest in the content of this type (travel in this example), the social networking system will continue to present the user with more and more of the same type. Frequently this provides the user with a positive and interesting experience. However, in some instances, it may lead to a situation commonly referred to as “rabbit holing,” in which users become engrossed or even obsessed with a single topic or type of content. For example, users may be quickly caught up in content of a certain type that they may lose track of time, forgetting what they were initially searching for. This can be problematic because the user is presented with content of the same type at the expense of other types of content in which the user may be equally interested, which can lead to a stale user experience. Additionally, the rabbit holing can be particularly problematic when the topic in which the user has expressed interest represents a biased or unrealistic representation of a subject (e.g., an unrealistic idea of body image or lifestyle), which can lead to unhealthy or unrealistic expectations.

Thus, this application describes techniques for helping users avoid and/or break out of a rabbit hole. The techniques may include suggesting content for users associated with accounts to view that is associated with a different topic than what they have been viewing, thereby nudging users to select a different and potentially equally or even more interesting topic of content to view. In some examples, these techniques may be applied when the social networking system determines that the user has or is likely to enter a rabbit hole (e.g., has viewed a threshold amount of content associated with a same topic). Additionally or alternatively, the techniques described herein may be applied to provide suggestions of topics of different types periodically (in terms of time and/or number of content items consumed) to help ensure that the user is presented with opportunities to view a variety of different types/topics of content. Rather than simply presenting content associated with a different topic, the techniques herein describe a dynamic and engaging tool which may offer accounts the option to consume content associated with different topics than they are currently interacting with. In this way, accounts are given a gentle reminder that they have been viewing similar content and are prompted to choose a new topic of content to consume. Thus, accounts are made aware of the type of content they are consuming, while being afforded with the flexibility and freedom to decide new content, if any, to consume.

Various examples of the present disclosure include systems, methods, and non-transitory computer-readable media of a social networking system. In some examples, a social networking system may receive, from an account of a social networking system, an indication of a first content item. The indication may comprise a touch input including at least one of a scroll gesture, a swipe gesture, and/or a tap gesture, to name a few non-limiting examples. The first content item may include, for example, at least a portion of a profile post, a story, a reel, and/or a direct message. In some examples, the social networking system may determine that the first content item is associated with a first topic. For example, the social networking system may employ a machine-learned model to identify one or more topics associated with the first content item. A topic may be an identifier, tag, or label associated with a content item that may assist the social networking system in organizing and filtering data. For example, a topic may be a broad category including a large portion of content, such as “people,” “products,” or “places,” to name a few non-limiting examples. In other examples, topics may include one or more sub-topics or categories of topics. Based at least in part on the topic associated with the first content item, the social networking system may determine that the user has interest in the first topic and may cause one or more additional content items associated with the topic to be presented or suggested to the user account.

In some examples, the social networking system may receive a request from the account to access a second content item. The second content item may, in some examples, be associated with the first topic. The social networking system may then, in some examples, cause presentation of the second content item associated with the first topic. For example, based at least in part on the request from the account to access the second content item, the social networking system may determine a second content item associated with the first topic.

In some examples, the social networking system may determine that the request from the account to access the second content item (or a subsequent content item associated with the first topic) meets or exceeds a threshold number of requests for content items associated with the first topic. For example, the social networking system may determine a threshold number of requests (e.g., 1 request, 5 requests, 10 requests, etc.) to access content items associated with the first topic. Based at least in part on determining that the request meets or exceeds a threshold number of requests for content items associated with the first topic, the social networking system may cause presentation of a suggested content item. The suggested content item may, in some examples, be associated with a second topic different than the first topic.

In some examples, the social networking system may present content to the account based at least in part on a selection of the suggested content item. For example, the request to access the second content item may be a first request. The social networking system may receive, from the account, an indication of a selection of the content item, and may then cause presentation of the suggested content item to the account. In some examples, the social networking system may then receive, from the account, a second request to access a third content item associated with the second topic. Based at least in part on the second request, the social networking system may cause presentation of the third content item.

In some examples, the suggested content item may be one of multiple suggested content items, allowing the account the ability to select which topic of content to further explore. For example, the suggested content item may be a first suggested content item. Based at least in part on determining that the request meets or exceeds the threshold number of requests, the social networking system may present a second suggested content item. In some examples, the second suggested content item may be associated with a third topic different than the second topic and may be presented as a smaller depiction and/or a portion of the second suggested content item. The social networking system may then receive, from the account of the social networking system, an indication of a selection of the second suggested content item. In some examples, the social networking system may then cause presentation of the second suggested content item. Presentation of the second suggested content item may include, for example, a presentation of a larger and/or complete version of the second suggested content item.

In some examples, the request to access the second content item may comprise a touch input including, by way of example and not limitation, a scroll gesture, a swipe gesture, and/or a tap gesture.

In some examples, the suggested content item may be based at least in part on content the account or other accounts associated with the account have interacted with. For example, causing presentation of the suggested content item may include determining the suggested content item, wherein determining the suggested content is based at least in part on a previous interaction by the account with a content item. In some examples, the previous interaction comprises the account providing an indication of interest, such as a “like,” a “love,” a “thumbs up,” a “celebrate,” a share, a comment, or a save, to name a few non-limiting examples. In other examples, the account may ignore the suggested content item, choosing to continue to view content associated with the first topic.

These techniques allow accounts viewing content associated with a topic the ability to choose content associated with a different topic to view instead. By suggesting content associated with topics different than the first topic, accounts are given both a gentle reminder to assess the content they are consuming, and the flexibility to determine what, if any, new content they may wish to consume.

These and other aspects are described further below with reference to the accompanying drawings. The drawings are merely example implementations, and should not be construed to limit the scope of the claims. For example, while examples are illustrated in the context of a user interface for a mobile device, the techniques may be implemented using any computing device and the user interface may be adapted to the size, shape, and configuration of the particular computing device.

### Example System Architecture

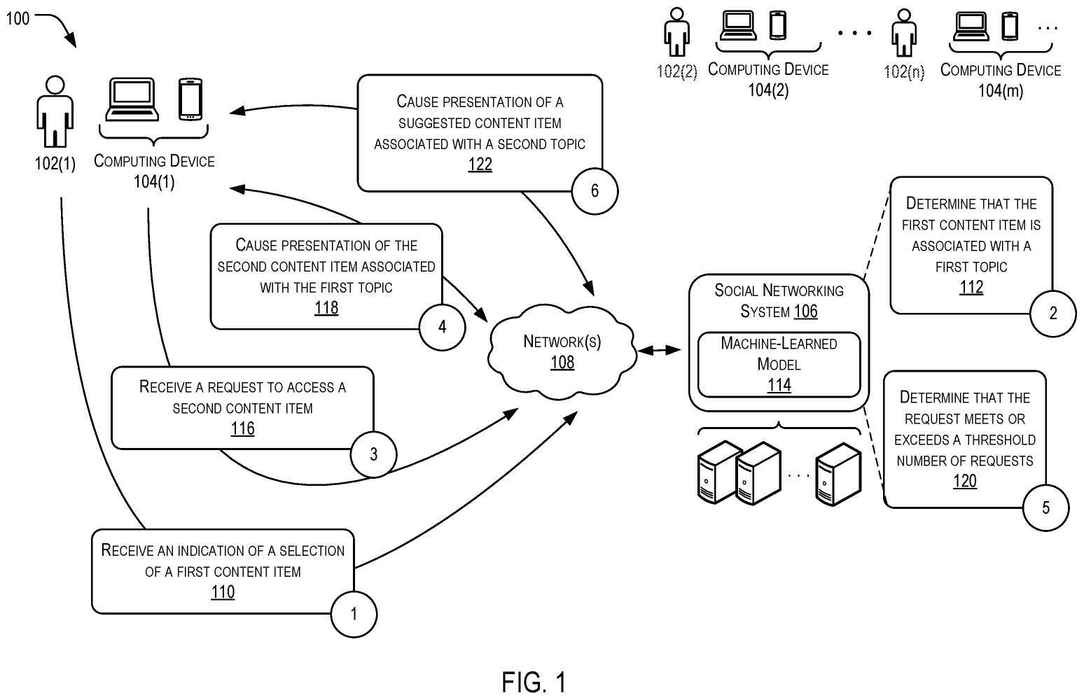

FIG. 1 is a schematic view of an example computing system 100 usable to implement example techniques described herein to prompt users associated with accounts of a social networking system to consume content associated with a topic different than they are currently consuming In some examples, the computing system 100 may include accounts 102(1), 102(2), . . . 102(n) (collectively “accounts 102”) that are associated with users and interact using computing devices 104(1), 104(2), . . . 104(m) (collectively “computing devices 104”) with a social networking system 106 via a network 108. In this example, n and m are non-zero integers greater than 1.

Each of the computing devices 104 includes one or more processors and memory storing computer-executable instructions to implement the functionality discussed herein attributable to the various computing devices. In some examples, the computing devices 104 may include desktop computers, laptop computers, tablet computers, mobile devices (e.g., smart phones or other cellular or mobile phones, mobile gaming devices, portable media devices, etc.), wearable devices (e.g., augmented reality or virtual reality devices, glasses, watches, etc.), or other suitable computing devices. The computing devices 104 may execute one or more client applications, such as a web browser (e.g., Microsoft Windows Internet Explorer, Mozilla Firefox, Apple Safari, Google Chrome, Opera, etc.) or a native or special-purpose client application (e.g., social media applications, messaging applications, email applications, games, etc.), to access and view content over the network 108.

The network 108 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which the computing devices 104 may access the social networking system 106 and/or communicate with one another.

The social networking system 106 may include one or more servers or other computing devices, any or all of which may include one or more processors and memory storing computer-executable instructions to implement the functionality discussed herein attributable to the social networking system 106 or digital platform. The social networking system 106 may enable accounts 102 associated with its users (such as persons or organizations) to interact with the social networking system 106 and with each other via the computing devices 104. The social networking system 106 may, with input from a user, create and store in the social networking system 106 a user account associated with the user. The user account may include demographic information, communication-channel information, financial information and information on personal interests of the user. The social networking system 106 may also, with input from a user, create and store a record of relationships of the user with other users of the social networking system 106, as well as provide services (e.g., posts, comments, photo-sharing, messaging, tagging, mentioning of other users or entities, games, etc.) to facilitate social interaction between or among the accounts 102.

The social networking system 106 may be configured to determine accounts that have consumed a threshold number of content items associated with a first topic and prompt the accounts to consume content items associated with a second topic, affording accounts both the choice to switch the type of content they are consuming and what type of new content they wish to consume, while still allowing the accounts to continue to consume additional content items associated with the first topic if they so choose. For example, at operation 110 (indicated by “1”), the social networking system 106 may receive, from an account of a social networking system, an indication of a selection of a first content item. In some examples, the indication of the selection of the first content item may comprise a touch input a scroll gesture, a swipe gesture, and/or a tap gesture.

Content, such as the first content item, may take a variety of forms. For example, content may include a profile or feed post, a story, a direct message to one or more other accounts, a reel, a tweet, or a snap, to name a few examples. In general, a profile (or feed) post may include text and/or media content items, such as images, video, and/or audio. The profile post may be published to the social networking system 106 by an account, such as the account 102(1), for consumption by other accounts 102(2)-102(n), and may be viewable by the other accounts 102(2)-102(n) for as long as the account 102(1) is active and/or until the post is deleted by the account 102(1), although examples are considered in which the profile post is removed and/or deleted after an amount of time (e.g., one hour, one day, one week, etc.). In some cases, a profile post shared by the account 102(1) may be included in respective content feeds of other the accounts 102(2)-102(n) of the social networking system 106 that have “followed” the first account 102(1), are “friends” with the account 102(1), are connections of the account 102(1) or are otherwise associated with the account 102(1).

A story may be similar to a profile post, in that the story may include text and/or media content items, such as images, video, and/or audio, is published to the social networking system 106 by the account 102(1) for consumption by the other accounts 102(2)-102(n), and may be included in a feed (although, in some cases, a separate feed from the profile post feed). However, a story may differ from a profile post in that the story may be shared only with a selected subset of the account's 102(1) followers, and/or may be removed from being viewed by followers of the account 102(1) after a certain period of time (e.g., one hour, one day, one week, etc.). A direct message may also include text and/or media content items, such as images, video, and/or audio, but in general, a direct message is shared with a single other account 102(n) of the social networking system 106, or a selected subset of other accounts 102(2)-102(n) of the social networking system 106 rather than shared with all of an account's 102 followers.

At operation 112 (indicated by a “2”), the social networking system 106 may determine that the first content item is associated with a first topic. For example, the social networking system 106 may employ one or more algorithms, filters, or models to identify one or more topics associated with the first content item. A topic may be an identifier associated with a content item that may assist the social networking system in organizing and filtering data. For example, a topic may be a label describing the content. In some examples, topics may be a broad category encompassing a large portion of content. For example, a topic may be “people,” “places,” or “products,” to name a few non-limiting examples. Additionally, topics may include one or more subtopics, which may include a category of a topic. For example, a “places” topic may include subtopics such as “tropical destination,” “Europe,” and “Washington State,” to name a few examples. Similar to topics, subtopics may include any number of subtopics, which may further specify a category content may be associated with. For example, the subtopic “Europe” may include the subtopic “Paris,” whereas the subtopic “Washington State” may further include the subtopic “Space Needle.”

By way of example, the social networking system 106 may receive the instruction to determine that the first content item is associated with a first topic from a machine-learned model 114 of the social networking system 106. For instance, the social networking system 106 may input the content into the machine-learned model 114 trained to determine a topic associated with the content. In some examples, the machine-learned model 114 may build a mathematical model using training data that includes content that has been previously associated with a topic. For example, training data may include one or more content items that have been associated with one or more pre-determined topics, such as those defined above. Using the training data, the machine-learned model 114 can be trained to label new content with existing topic labels as the content is received by the social networking system 106.

The machine-learned model 114 may take a variety of forms. For instance, the machine-learned model 114 may be a computer-vision classifier trained to analyze images and/or video (e.g., a frame and/or frames of a video) for images and/or videos that may be associated with one or more topics. The computer-vision classifier, in some examples, may be an artificial neural network trained to define a set of target topics from content (e.g., images, video, etc.) and determine one or more topics to be associated with new content as it is received by the social networking system 106 from one or more of the accounts 102. For example, the machine-learned model 114 may receive the content from the account 102(1) and using key images, output a score associated with one or more topics. The machine-learned model 114 may compare the one or more scores, and based at least in part on determining, the highest score associated with a topic, associate that content with the topic with the highest score or potentially associate the content with multiple topics based on the scores (e.g., all scores above a threshold score).

Accordingly, the machine-learned model 114 may include a number of additional or alternative classifiers to analyze the different content types of content received from the account 102(1). For example, the machine-learned model 114 may include an artificial neural network including a speech recognition classifier trained to analyze speech or other audio included in a video or audio recording to determine one or more topics associated with the video or audio. As another example, the machine-learned model 114 may include a text classifier, such as an artificial neural network, trained to identify a topic associated with content. Further, the machine-learned model 114 may include an optical character recognition (OCR) classifier, which when given an image representing printed text (e.g., in a GIF, sticker, characters traced onto a touch screen using a finger or stylus, etc.), determines the corresponding text. The OCR classifier may output the text to a text classifier trained to identify one or more topics, as described above.

Although specific machine-learned models are described above, other types of machine-learned models can additionally or alternatively be used. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like.

At operation 116 (indicated by a “3”), the social networking system 106 may receive a request from the account to access a second content item. In some examples, the second content item may be associated with the first topic. Similar to the indication of the selection of the first content item, the request to access the second content item may comprise a touch input including a scroll gesture, a swipe gesture, and/or a tap gesture.

At operation 118 (indicated by a “4”), the social networking system may cause presentation of the second content item associated with the first topic. In some examples, based at least in part on the request from the account 102(1) to access the second content item, the social networking system 106 may determine a second content item associated with the topic that the first content item is associated with. For example, the first content item may be a photo of a girl alongside a dog. As described with regard to operation 112, the machine-learned model 114 of the social networking system 106 may determine that the first topic item is associated with the topic “dogs.” Thus, the social networking system may cause presentation of a second content item similarly associated with the topic “dogs,” such as a content item including an image of a dog.

At operation 120 (indicated by a “5”), the social networking system 106 may determine that the request to access the second content item meets or exceeds a threshold number of requests for content items associated with the first topic. For example, the social networking system 106 may determine a threshold number of requests (e.g., 1 request, 5 requests, 10 requests, etc.) by the account 102(1) to access the second content item. In some examples, the threshold may be a variable threshold which may be adjusted based on one or more characteristics associated with the account and/or the first topic. The threshold may be set relatively higher for accounts that have a history of not going down rabbit holes and/or have a history of successfully breaking out of a rabbit hole, or for topics that are not associated with unhealthy, unrealistic, or objectionable content. Conversely, in some examples, the threshold may be set relatively lower for accounts that have a history of going down rabbit holes, not being able to break out of a rabbit hole on their own, and/or for topics that are known to be associated with unhealthy, unrealistic, or objectionable content.

In some examples, the threshold number of requests may be based at least in part on a type of content, such as a profile post, a feed post, a reel, or a story, to name a new examples, wherein the first content item and the second content item include the same type of content. Thus, the social networking system may determine a threshold number of requests to access a type of content (e.g., 1 request to access a profile post, 5 requests to access a profile post, 10 requests to access a profile post, etc.). Additionally, or alternatively, the social networking system may determine an amount of time, in some examples, the threshold number of requests may be associated with an amount of time. For example, the social networking system 106 may determine an amount of time (e.g., 1 minute, 10 minutes, 20 minutes, 1 hour, etc.), and determine if the request to access the second content meets or exceeds a threshold number of requests for content associated with the topic at or within the amount of time. In this way, the social networking system may prompt users to view different content based on a number of requests, a type of content, and/or a time period in which content has been accessed.

At operation 122 (indicated by a “6”), the social networking system 106 may cause presentation, based at least in part on the request meeting or exceeding the threshold number of requests, of a suggested content item associated with a second topic different than the first topic. For example, and continuing with the illustrative example above, the social networking system 106 may determine a suggested content item associated with a topic different than the topic “dogs,” which the first content item and the second content item are associated with. Thus, for example, the social networking system may cause presentation of a suggested content item associated with a topic such as “food,” such as a photo of donuts. In this way, the user associated with the account 102(1) is gently prompted to choose a different type of content to view.

In some examples, the social networking system 106 may determine certain suggested content items may be more or less desirable for consumption by the account 102(1), thus making that content more or less likely to be presented to the account 102(1) by the social networking system as a suggested content item. For example, based at least in part on determining that the request to access the second content item meets or exceeds the threshold number of requests for content items associated with the first topic, the social networking system 106 may instruct the machine-learned model 114 to determine one or more suggested content items.

Similar to determining a topic associated with content, the machine-learned model 114 may be trained to determine content items that may be of interest to suggest to the account 102(1). For example, the machine-learned model 114 may build a mathematical model using training data including interactions by the account 102(1) and/or other accounts 102(n) associated with the account 102(1) with the content items. Based at least in part on a type of interaction (e.g., viewing, sharing, commenting, liking, etc.) and/or a sentiment (e.g., a positive or a negative interaction), the machine-learned model may determine that a content item is more or less likely to be of interest to the account 102(1), thus making that content more or less likely to be presented by the social networking system 106 as a suggested content item.

Additionally, or alternatively, the social networking system 106 may determine that content is more or less likely to be presented as a suggested content item based at least in part on trending content in a geographic area associated with the first account 102(1). For example, the social networking system 106 may determine a geographic area associated with a location of the device 104(1) associated with the first account 102(1). The machine-learned model may then determine that content associated with the geographic area that is trending content. For example, the machine-learned model may determine a threshold level of engagement (e.g., 10,000 or more shares, 5,000 or more likes, etc.) and based at least in part on determining that the content associated with the geographic location exceeds the threshold level of engagement, may determine that content is more likely to be presented, to the first account 102(1), as a suggested content item.

In some examples, training data may include one or more content items that the user 102(1) and/or another account 102(n) associated with the account 102(1) (e.g., a follower of the account 102(1), an account 102(n) the account follows, etc.) has interacted with. For example, an interaction may include an indication of interest, such as a “like,” a “love,” a “thumbs up,” a “celebrate,” sharing the content, commenting on the content, saving the content, to name a few nonlimiting examples. Additionally, or alternatively, the interaction may include an indication of a lack of interest, such as a “thumbs down,” ignoring the content, selecting an “X” associated with the content, reporting the content, etc. The machine-learned model 114 may then determine one or more topics associated with the content items the account 102(1) and/or other accounts 102(n) have interreacted with, and determine a score associated with each content item. The machine-learned model 114 may then determine the scores, assigning higher scores to content items that are associated with positive interactions. The weightings used by the machine-learned model may be learned and adjusted by the machine-learned model during offline and/or online training. The social networking system 106 may determine, based at least in part on the scores output by the machine-learned model 114, topics associated with content that is more likely to be of interest to the account 102(2), thus making that content more likely to be suggested content items.

In some examples, a selection of the suggested content item by the account 102(1) may prompt the social networking system 106 to present, to the first account 102(1), content associated with that the suggested topic is associated with. For example, the request to access the second content item may be a first request, and the social networking system 106 may receive, from the account 102(1), an indication of a selection of the suggested content item. Similar to that of receiving the selection of the first content item and receiving the request to access the second content item, the selection of the suggested content item may comprise a touch input including at least one of a scroll gesture, a swipe gesture, and/or a tap gesture. Based at least in part on receiving the selection of the suggested content item, the social networking system 106 may then cause presentation of the suggested content item. For example, the suggested content item, as first presented by the social networking system 106 based at least in part on the request to access the second content item meeting or exceeding the threshold number of requests, may be presented by the social networking system 106 as a preview of the suggested content item. In other words, the suggested content item may be displayed as a smaller depiction of the suggested content item, and/or a portion of the suggested content item, for example. Thus, presenting the content item may include presenting a larger and/or complete version of the suggested content item.

In some examples, the social networking system 106 may then receive, from the account, a second request to access a third content item. The third content item may, in some examples, be associated with the second topic. Based at least in part on receiving the second request, the social networking system 106 may then cause presentation of the third content item. Continuing with the illustrative example above, the second topic may be “food” and the suggested content item may be a photo of donuts. Thus, the social networking system 106 may present a content item associated with “food,” such as a photo of pizza. In this way, not only is the user associated with the account 102(1) given the option to view a different type of content but that user is presented with various content of that type, allowing the user to diversify their content consumption.

In some examples, suggested content item may be one of multiple suggested content items, allowing the user associated with the account 120(1) the option to choose which new topic of content they wish to view. For example, the suggested content item may be a first content item. Based at least in part on determining that the request from the account to access a second content meets or exceeds the threshold number of requests, the social networking system may cause presentation of a second suggested content item. The second suggested content item may be, in some examples, associated with a third topic different than the first topic and the second topic. Continuing with the illustrate example above, the first topic may be “dogs” and the first suggested content item may be associated with the topic “food.” The social networking system 106 may determine a second suggested content item associated with a topic different than “dogs” and “food,” and may thus determine the third topic is “travel,” and determine the second suggested content item is an image of a popular tourist destination, such as a monument.

In some examples, the social networking system 106 may then receive, from the account 102(1), an indication of a selection of the second suggested content item. Based at least in part on receiving an indication of the selection of the second suggested content item, the social networking system 106 may then cause presentation of the second suggested content item. Similar to that described above with respect to the first suggested content item, the second suggested content item may be displayed, by the social networking system 106, as a smaller depiction of the second suggested content item or a portion of the second suggested content item, for example.

Based at least in part on receiving the indication of the selection of the second suggested content item, the social networking system 106 may cause presentation of the second suggested content item. Presentation of the second suggested content item may include, for example, a presentation of a complete content item, such that the account 102(1) may comment on, like, save, and share the content item, to name a few examples.

In some examples, the social networking system 106 may further receive, from the account, a second request to access a third content item associated with the third topic. Based at least in part on the second request, the social networking system 106 may then cause presentation of the third content item. For example, continuing with the illustrative example above, the third topic may be “travel” and the second suggested content item may be an image of a popular monument. Based at least in part in receiving the second request to access the third content item, the social networking system 106 may determine the third content item based at least in part on determining that the second suggested content item is associated with the third topic. Thus, the social networking system 106 may determine the third content item also associated with the topic “travel,” and may thus select an image of a vacation hotspot, such a popular beach.

In some examples, the social networking system 106 may provide privacy features to the accounts 102. In particular examples, one or more objects (e.g., content or other types of objects) of the computing system 100 may be associated with one or more privacy settings. The one or more objects may be stored on or otherwise associated with any suitable computing system or application, such as, for example, the social networking system 106, a client system, a third-party system, a social networking application, a messaging application, a photo-sharing application, or any other suitable computing system or application. Although the examples discussed herein are in the context of an online social network, these privacy settings may be applied to any other suitable computing system. Privacy settings (or “access settings”) for an object or item of content may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular account or other entity to access that object, the object may be described as being “visible” with respect to that account or other entity. As an example, and not by way of limitation, an account of the social networking system 106 may specify privacy settings for a account-profile page that identify a set of accounts that may access work-experience information on the account-profile page, thus excluding other accounts from accessing that information.

In particular examples, privacy settings for an object may specify a “blocked list” and/or a “restricted list” of accounts or other entities that should not be allowed to access certain information associated with the object. In particular examples, the blocked list may include third-party entities. The blocked list or restricted list may specify one or more accounts or entities for which an object is not visible. As an example, and not by way of limitation, an account may specify a set of accounts who may not access photo albums associated with the account, thus excluding those accounts from accessing the photo albums (while also possibly allowing certain accounts not within the specified set of accounts to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example, and not by way of limitation, a particular concept node corresponding to a particular photo may have a privacy setting specifying that the photo may be accessed only by accounts tagged in the photo and friends of the accounts tagged in the photo. In particular examples, privacy settings may allow accounts to opt in to or opt out of having their content, information, or actions stored/logged by the social networking system 106 or shared with other systems (e.g., a third-party system). Although this disclosure describes using particular privacy settings in a particular manner, this disclosure contemplates using any suitable privacy settings in any suitable manner.

In particular examples, privacy settings may be based on one or more nodes or edges of a social graph. A privacy setting may be specified for one or more edges or edge-types of the social graph, or with respect to one or more nodes or node-types of the social graph. The privacy settings applied to a particular edge connecting two nodes may control whether the relationship between the two entities corresponding to the nodes is visible to other accounts of the online social network. Similarly, the privacy settings applied to a particular node may control whether the account or concept corresponding to the node is visible to other accounts of the online social network. As an example, and not by way of limitation, the first account 102(1) may share an object to the social networking system 106. The object may be associated with a concept node connected to an account node of the first account 102(1) by an edge. The first account 102(1) may specify privacy settings that apply to a particular edge connecting to the concept node of the object or may specify privacy settings that apply to all edges connecting to the concept node. As another example and not by way of limitation, the first account 102(1) may share a set of objects of a particular object-type (e.g., a set of images). The first account 102(1) may specify privacy settings with respect to all objects associated with the first account 102(1) of that particular object-type as having a particular privacy setting (e.g., specifying that all images posted by the first account 102(1) are visible only to friends of the first account 102(1) and/or accounts tagged in the images).

In particular examples, the social networking system 106 may present a “privacy wizard” (e.g., within a webpage, a module, one or more dialog boxes, or any other suitable interface) to the first account 102(1) to assist the first account 102(1) in specifying one or more privacy settings. The privacy wizard may display instructions, suitable privacy-related information, current privacy settings, one or more input fields for accepting one or more inputs from the first account 102(1) specifying a change or confirmation of privacy settings, or any suitable combination thereof. In particular examples, the social networking system 106 may offer a “dashboard” functionality to the first account 102(1) that may display, to the first account 102(1), current privacy settings of the first account 102(1). The dashboard functionality may be displayed to the first account 102(1) at any appropriate time (e.g., following an input from the first account 102(1) summoning the dashboard functionality, following the occurrence of a particular event or trigger action). The dashboard functionality may allow the first account 102(1) to modify one or more of the first account 102(1)'s current privacy settings at any time, in any suitable manner (e.g., redirecting the first account 102(1) to the privacy wizard).

Privacy settings associated with an object may specify any suitable granularity of permitted access or denial of access, including the “restrict” functionality described herein. As an example and not by way of limitation, access or denial of access may be specified for particular accounts (e.g., only me, my roommates, my boss), accounts within a particular degree-of-separation (e.g., friends, friends-of-friends), account groups (e.g., the gaming club, my family), account networks (e.g., employees of particular employers, students or alumni of particular university), all accounts (“public”), no accounts (“private”), accounts of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, one or more servers may be authorization/privacy servers for enforcing privacy settings. In response to a request from an account (or other entity) for a particular object stored in a data store, the social networking system 106 may send a request to the data store for the object. The request may identify the account associated with the request and the object may be sent only to the account (or a client system of the account) if the authorization server determines that the account is authorized to access the object based on the privacy settings associated with the object. If the requesting account is not authorized to access the object, the authorization server may prevent the requested object from being retrieved from the data store or may prevent the requested object from being sent to the account. In the search-query context, an object may be provided as a search result only if the querying account is authorized to access the object, e.g., if the privacy settings for the object allow it to be surfaced to, discovered by, or otherwise visible to the querying account. In particular examples, an object may represent content that is visible to an account through a newsfeed of the account. As an example, and not by way of limitation, one or more objects may be visible to a account's “Trending” page. In particular examples, an object may correspond to a particular account. The object may be content associated with the particular account or may be the particular account's account or information stored on the social networking system 106, or other computing system. As an example, and not by way of limitation, a first account 102(1) may view one or more second accounts of an online social network through a “People You May Know” function of the online social network, or by viewing a list of friends of the first account 102(1). As an example, and not by way of limitation, a first account 102(1) may specify that they do not wish to see objects associated with a particular second account in their newsfeed or friends list. If the privacy settings for the object do not allow it to be surfaced to, discovered by, or visible to the account, the object may be excluded from the search results. Although this disclosure describes enforcing privacy settings in a particular manner, this disclosure contemplates enforcing privacy settings in any suitable manner.

In particular examples, different objects of the same type associated with an account may have different privacy settings. Different types of objects associated with an account may have different types of privacy settings. As an example, and not by way of limitation, a first account 102(1) may specify that the first account 102(1)'s status updates are public, but any images shared by the first account 102(1) are visible only to the first account 102(1)'s friends on the online social network. As another example and not by way of limitation, an account may specify different privacy settings for different types of entities, such as individual accounts, friends-of-friends, followers, account groups, or corporate entities. As another example and not by way of limitation, a first account 102(1) may specify a group of accounts that may view videos posted by the first account 102(1), while keeping the videos from being visible to the first account 102(1)'s employer. In particular examples, different privacy settings may be provided for different account groups or account demographics. As an example, and not by way of limitation, a first account 102(1) may specify that other account who attend the same university as the first account 102(1) may view the first account 102(1)'s pictures, but that other account who are family members of the first account 102(1) may not view those same pictures.

In particular examples, the social networking system 106 may provide one or more default privacy settings for each object of a particular object-type. A privacy setting for an object that is set to a default may be changed by an account associated with that object. As an example, and not by way of limitation, all images posted by a first account 102(1) may have a default privacy setting of being visible only to friends of the first account 102(1) and, for a particular image, the first account 102(1) may change the privacy setting for the image to be visible to friends and friends-of-friends.

In particular examples, privacy settings may allow a first account 102(1) to specify (e.g., by opting out, by not opting in) whether the social networking system 106 may receive, collect, log, or store particular objects or information associated with the account for any purpose. In particular examples, privacy settings may allow the first account 102(1) to specify whether particular applications or processes may access, store, or use particular objects or information associated with the account. The privacy settings may allow the first account 102(1) to opt in or opt out of having objects or information accessed, stored, or used by specific applications or processes. The social networking system 106 may access such information in order to provide a particular function or service to the first account 102(1), without the social networking system 106 having access to that information for any other purposes. Before accessing, storing, or using such objects or information, the social networking system 106 may prompt the account to provide privacy settings specifying which applications or processes, if any, may access, store, or use the object or information prior to allowing any such action. As an example, and not by way of limitation, a first account 102(1) may transmit a message to a second account via an application related to the online social network (e.g., a messaging app), and may specify privacy settings that such messages should not be stored by the social networking system 106.

In particular examples, an account may specify whether particular types of objects or information associated with the first account 102(1) may be accessed, stored, or used by the social networking system 106. As an example, and not by way of limitation, the first account 102(1) may specify that images sent by the first account 102(1) through the social networking system 106 may not be stored by the social networking system 106. As another example and not by way of limitation, a first account 102(1) may specify that messages sent from the first account 102(1) to a particular second account may not be stored by the social networking system 106. As yet another example and not by way of limitation, a first account 102(1) may specify that all objects sent via a particular application may be saved by the social networking system 106.

In particular examples, privacy settings may allow a first account 102(1) to specify whether particular objects or information associated with the first account 102(1) may be accessed from particular client systems or third-party systems. The privacy settings may allow the first account 102(1) to opt in or opt out of having objects or information accessed from a particular device (e.g., the phone book on an account's smart phone), from a particular application (e.g., a messaging app), or from a particular system (e.g., an email server). The social networking system 106 may provide default privacy settings with respect to each device, system, or application, and/or the first account 102(1) may be prompted to specify a particular privacy setting for each context. As an example, and not by way of limitation, the first account 102(1) may utilize a location-services feature of the social networking system 106 to provide recommendations for restaurants or other places in proximity to the account. The first account 102(1)'s default privacy settings may specify that the social networking system 106 may use location information provided from a client device of the first account 102(1) to provide the location-based services, but that the social networking system 106 may not store the location information of the first account 102(1) or provide it to any third-party system. The first account 102(1) may then update the privacy settings to allow location information to be used by a third-party image-sharing application in order to geo-tag photos.

Privacy Settings for Mood, Emotion, or Sentiment Information

In particular examples, privacy settings may allow an account to specify whether current, past, or projected mood, emotion, or sentiment information associated with the account may be determined, and whether particular applications or processes may access, store, or use such information. The privacy settings may allow accounts to opt in or opt out of having mood, emotion, or sentiment information accessed, stored, or used by specific applications or processes. The social networking system 106 may predict or determine a mood, emotion, or sentiment associated with an account based on, for example, inputs provided by the account and interactions with particular objects, such as pages or content viewed by the account, posts or other content uploaded by the account, and interactions with other content of the online social network. In particular examples, the social networking system 106 may use an account's previous activities and calculated moods, emotions, or sentiments to determine a present mood, emotion, or sentiment. An account who wishes to enable this functionality may indicate in their privacy settings that they opt into the social networking system 106 receiving the inputs necessary to determine the mood, emotion, or sentiment. As an example, and not by way of limitation, the social networking system 106 may determine that a default privacy setting is to not receive any information necessary for determining mood, emotion, or sentiment until there is an express indication from an account that the social networking system 106 may do so. By contrast, if an account does not opt in to the social networking system 106 receiving these inputs (or affirmatively opts out of the social networking system 106 receiving these inputs), the social networking system 106 may be prevented from receiving, collecting, logging, or storing these inputs or any information associated with these inputs. In particular examples, the social networking system 106 may use the predicted mood, emotion, or sentiment to provide recommendations or advertisements to the account. In particular examples, if an account desires to make use of this function for specific purposes or applications, additional privacy settings may be specified by the account to opt in to using the mood, emotion, or sentiment information for the specific purposes or applications. As an example, and not by way of limitation, the social networking system 106 may use the account's mood, emotion, or sentiment to provide newsfeed items, pages, friends, or advertisements to an account. The account may specify in their privacy settings that the social networking system 106 may determine the account's mood, emotion, or sentiment. The account may then be asked to provide additional privacy settings to indicate the purposes for which the account's mood, emotion, or sentiment may be used. The account may indicate that the social networking system 106 may use his or her mood, emotion, or sentiment to provide newsfeed content and recommend pages, but not for recommending friends or advertisements. The social networking system 106 may then only provide newsfeed content or pages based on account mood, emotion, or sentiment, and may not use that information for any other purpose, even if not expressly prohibited by the privacy settings.

Privacy Settings for Ephemeral Sharing

In particular examples, privacy settings may allow an account to engage in the ephemeral sharing of objects on the online social network. Ephemeral sharing refers to the sharing of objects (e.g., posts, photos) or information for a finite period of time. Access or denial of access to the objects or information may be specified by time or date. As an example, and not by way of limitation, an account may specify that a particular image uploaded by the account is visible to the account's friends for the next week, after which time the image may no longer be accessible to other accounts. As another example and not by way of limitation, a company may post content related to a product release ahead of the official launch and specify that the content may not be visible to other accounts until after the product launch.

In particular examples, for particular objects or information having privacy settings specifying that they are ephemeral, the social networking system 106 may be restricted in its access, storage, or use of the objects or information. The social networking system 106 may temporarily access, store, or use these particular objects or information in order to facilitate particular actions of an account associated with the objects or information, and may subsequently delete the objects or information, as specified by the respective privacy settings. As an example, and not by way of limitation, a first account 102(1) may transmit a message to a second account, and the social networking system 106 may temporarily store the message in a data store until the second account has viewed or downloaded the message, at which point the social networking system 106 may delete the message from the data store. As another example and not by way of limitation, continuing with the prior example, the message may be stored for a specified period of time (e.g., 2 weeks), after which point the social networking system 106 may delete the message from the data store.

Privacy Settings for Account-Authentication and Experience-Personalization Information

In particular examples, the social networking system 106 may have functionalities that may use, as inputs, personal or biometric information of a user associated with an account for user-authentication or experience-personalization purposes. An account may opt to make use of these functionalities to enhance their experience on the online social network. As an example, and not by way of limitation, an account may provide personal or biometric information to the social networking system 106. The account's privacy settings may specify that such information may be used only for particular processes, such as authentication, and further specify that such information may not be shared with any third-party system or used for other processes or applications associated with the social networking system 106. As another example and not by way of limitation, the social networking system 106 may provide a functionality for an account to provide voice-print recordings to the online social network. As an example, and not by way of limitation, if an account wishes to utilize this function of the online social network, the user associated with the account may provide a voice recording of his or her own voice to provide a status update on the online social network. The recording of the voice-input may be compared to a voice print of the user associated with the account to determine what words were spoken by the account. The account's privacy setting may specify that such voice recording may be used only for voice-input purposes (e.g., to authenticate the account, to send voice messages, to improve voice recognition in order to use voice-operated features of the online social network), and further specify that such voice recording may not be shared with any third-party system or used by other processes or applications associated with the social networking system 106. As another example and not by way of limitation, the social networking system 106 may provide a functionality for an account to provide a reference image (e.g., a facial profile, a retinal scan) to the online social network. The online social network may compare the reference image against a later-received image input (e.g., to authenticate the account, to tag the account in photos). The account's privacy setting may specify that such voice recording may be used only for a limited purpose (e.g., authentication, tagging the account in photos), and further specify that such voice recording may not be shared with any third-party system or used by other processes or applications associated with the social networking system 106.

Account-Initiated Changes to Privacy Settings

In particular examples, changes to privacy settings may take effect retroactively, affecting the visibility of objects and content shared prior to the change. As an example, and not by way of limitation, a first account 102(1) may share a first image and specify that the first image is to be public to all other accounts. At a later time, the first account 102(1) may specify that any images shared by the first account 102(1) should be made visible only to a group associated with the first account 102(1). The social networking system 106 may determine that this privacy setting also applies to the first image and make the first image visible only to the first account's 102(1) group. In particular examples, the change in privacy settings may take effect only going forward. Continuing the example above, if the first account 102(1) changes privacy settings and then shares a second image, the second image may be visible only to the first account's 102(1) group, but the first image may remain visible to all accounts. In particular examples, in response to an account action to change a privacy setting, the social networking system 106 may further prompt the account to indicate whether the account wants to apply the changes to the privacy setting retroactively. In particular examples, an account change to privacy settings may be a one-off change specific to one object. In particular examples, an account change to privacy may be a global change for all objects associated with the account.

In particular examples, the social networking system 106 may determine that a first account 102(1) may want to change one or more privacy settings in response to a trigger action associated with the first account 102(1). The trigger action may be any suitable action on the online social network. As an example, and not by way of limitation, a trigger action may be a change in the relationship between a first and second account of the online social network (e.g., “un-friending” an account, changing the relationship status between the accounts). In particular examples, upon determining that a trigger action has occurred, the social networking system 106 may prompt the first account 102(1) to change the privacy settings regarding the visibility of objects associated with the first account 102(1). The prompt may redirect the first account 102(1) to a workflow process for editing privacy settings with respect to one or more entities associated with the trigger action. The privacy settings associated with the first account 102(1) may be changed only in response to an explicit input from the first account 102(1) and may not be changed without the approval of the first account 102(1). As an example and not by way of limitation, the workflow process may include providing the first account 102(1) with the current privacy settings with respect to the second account or to a group of accounts (e.g., un-tagging the first account 102(1) or second account from particular objects, changing the visibility of particular objects with respect to the second account or group of accounts), and receiving an indication from the first account 102(1) to change the privacy settings based on any of the methods described herein, or to keep the existing privacy settings.

In particular examples, an account may need to provide verification of a privacy setting before allowing the account to perform particular actions on the online social network, or to provide verification before changing a particular privacy setting. When performing particular actions or changing a particular privacy setting, a prompt may be presented to the account to remind the account of his or her current privacy settings and to ask the account to verify the privacy settings with respect to the particular action. Furthermore, an account may need to provide confirmation, double-confirmation, authentication, or other suitable types of verification before proceeding with the particular action, and the action may not be complete until such verification is provided. As an example, and not by way of limitation, an account's default privacy settings may indicate that a person's relationship status is visible to all accounts (i.e., “public”). However, if the account changes his or her relationship status, the social networking system 106 may determine that such action may be sensitive and may prompt the account to confirm that his or her relationship status should remain public before proceeding. As another example and not by way of limitation, an account's privacy settings may specify that the account's posts are visible only to friends of the account. However, if the account changes the privacy setting for his or her posts to being public, the social networking system 106 may prompt the accounts with a reminder of the account's current privacy settings of posts being visible only to friends, and a warning that this change will make all of the account's past posts visible to the public. The account may then be required to provide a second verification, input authentication credentials, or provide other types of verification before proceeding with the change in privacy settings. In particular examples, an account may need to provide verification of a privacy setting on a periodic basis. A prompt or reminder may be periodically sent to the account based either on time elapsed or a number of account actions. As an example, and not by way of limitation, the social networking system 106 may send a reminder to the account to confirm his or her privacy settings every six months or after every ten photo posts. In particular examples, privacy settings may also allow accounts to control access to the objects or information on a per-request basis. As an example, and not by way of limitation, the social networking system 106 may notify the account whenever a third-party system attempts to access information associated with the account and require the account to provide verification that access should be allowed before proceeding.

### Example User Interfaces

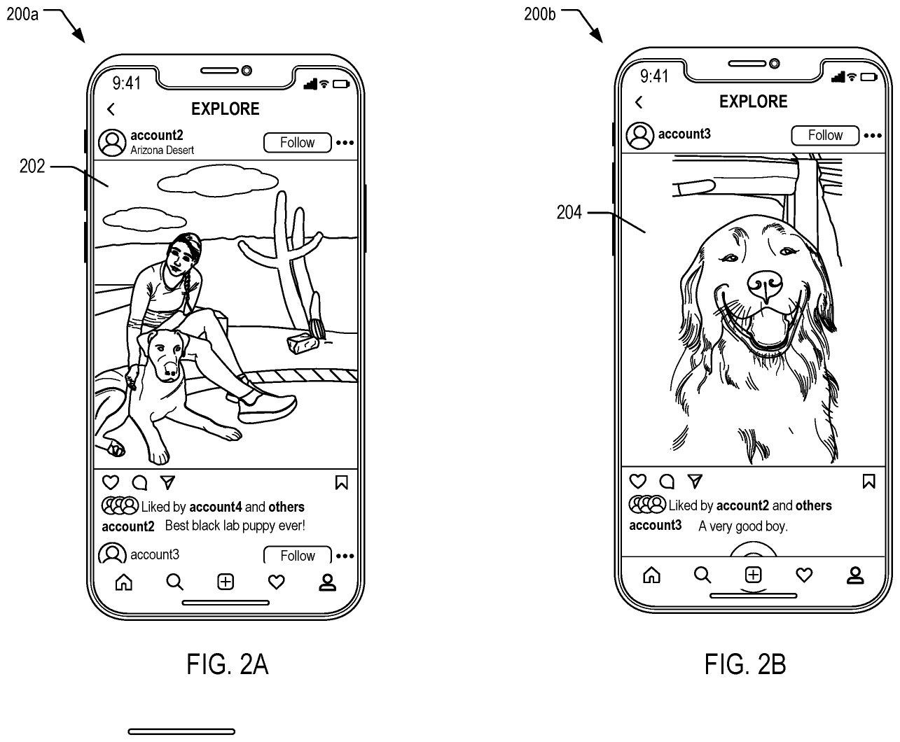

FIG. 2A-FIG. 4 are schematic views showing example user interfaces that are usable to implement the techniques described herein for suggesting content items. The interfaces and/or the notifications may be generated by a computing device of a social networking system (e.g., social networking system 106) and transmitted to one or more user computing devices (e.g., computing devices 104) for presentation, and/or the interfaces may be generated by the one or more user computing devices based at least in part on instructions received from the social networking system 106. As discussed above, the interfaces described in this section may, but need not, be implemented in the context of the computing system 100.

FIGS. 2A and 2B illustrate example interfaces for generating a suggested content item. FIG. 2A illustrates a user interface 200a depicting a first content item 202, containing an image of a girl and her dog. For example, as shown in FIG. 2A, upon detection of an indication by the account 102(1) of a selection of a first content item, such as first content item 202, the machine-learned model 114 of the social networking system 106 may determine a topic associated with the first content item. For example, the machine-learned model 114 may rely on computer-vision classifiers to analyze images associated with content (e.g., the image of a girl and her dog) and/or text classifiers to analyze text associated with content (e.g., the caption “Best black lab puppy ever!”) to determine a topic associated with the content item. In the current embodiment, the social networking system 106 has determined that the first content item 202 is associated with the topic “dogs.”

In some examples, as illustrated by FIG. 2B, the account may request to access a second content item. In response to receiving the request, the social networking system 106 may determine a second content item associated with the first topic. Thus, FIG. 2B depicts a user interface 200b including a second content item 204, containing a photo of a Golden Retriever, which is associated with the first topic “dogs.”

In some examples, the social networking system may determine that the account 102(1) has exceeded a threshold number of requests to access content items associated with a first topic (e.g., the first content item 202 and the second content item 204 associated with the topic “dogs”) and may suggest, to the account 102(1) one or more content items associated with one or more different topics to view.

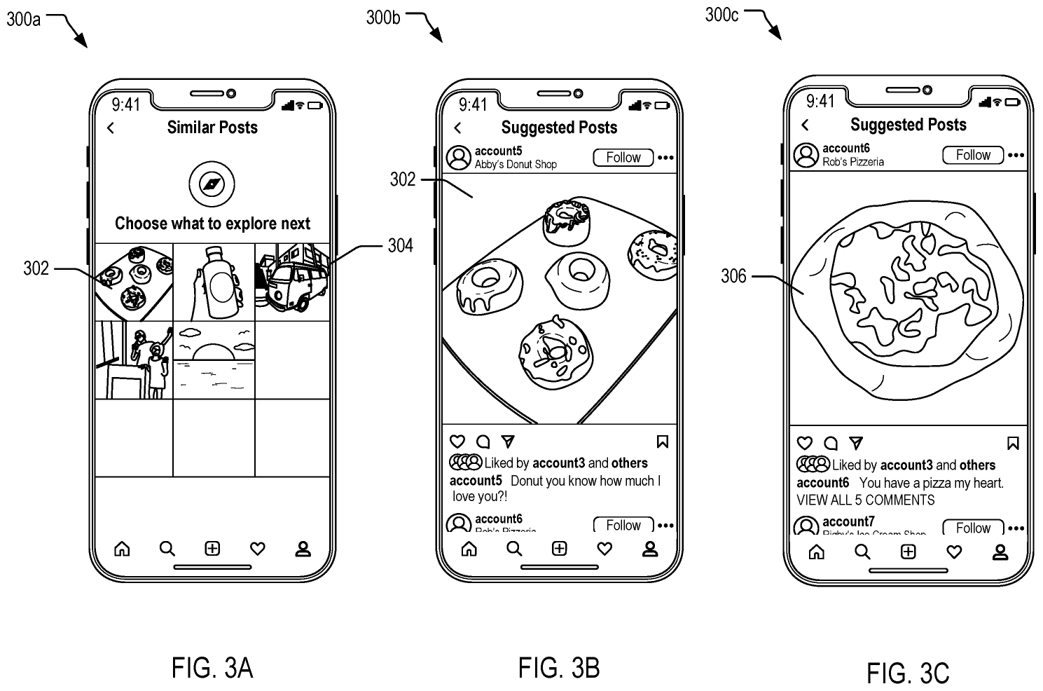

FIG. 3A-3C illustrate example interfaces including suggested content items for the account 102(1) to view. FIG. 3A illustrates an example user interface 300a usable to determine a suggested content item. For example, based at least in part on determining that the requests, by the account 102(1), to access a second content item associated with the first topic meets or exceeds a threshold number of requests (e.g., 2 requests, 5 requests, 10, requests, etc.), the social networking system 106 may determine one or more suggested content items associated with topics different than the first topic, such as suggested content item 302. Suggested content item 302 depicts a photo of donuts, which is associated with the topic “food.” In some examples, the user interface 300a may include multiple suggested content items which may be associated with additional topics, such as suggested content item 304, illustrating a popular tourist attraction, associated with the topic “travel.”

Upon selecting the suggested content item, such as suggested content item 302, the account 102(1) may be presented with the suggested content item 302, as illustrated in user interface 300b in FIG. 3B. While the suggested content item 302, when presented in user interface 300a, may be presented as a preview, the suggested content item 302 may be presented in user interface 300b as a complete content item, such that the account 102(1) may comment on, like, save, and share the content item 302, to name a few examples.

In some examples, similar to that depicted in FIG. 2B, the account 102(1) may choose to view additional content associated with the second topic. FIG. 3C illustrates example interface 300c usable to access a third content item, such as third content item 306, associated with the second topic. For example, based at least in part on receiving a request from the account 102(1) to access a third content item associated with the second topic, the social networking system 106 may determine a third content item associated with the second topic, “food,” thus presenting an image of pizza.

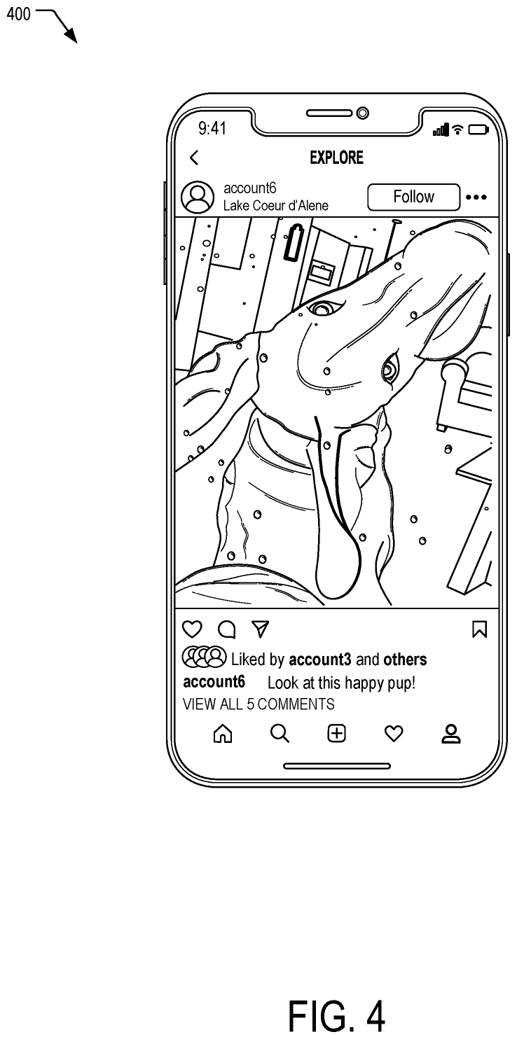

In some examples, the account 102(1) may wish to keep viewing content associated with the first topic, opting to ignore the suggested content item. FIG. 4 illustrates an example interface 400 in which the account 102(1) has chosen to continue viewing content associated with the first topic, “dogs.” For example, in response to displaying the suggested content item, such as that illustrated in FIG. 3A, the social networking system 106 may receive, from the account 102(1), a lack of interest. A lack of interest may include a scroll gesture, a swipe gesture, a selection of an “X”, to name a few non-limiting examples. Based at least in part on receiving the indication of lack of interest, the social networking system 106 may present, to the account 102(1), a fourth content item associated with the first topic. As illustrated in FIG. 4, the social networking system has presented, to the account 102(1), an image of a Great Dane, associated with the first topic “dogs.” In this way, users associated with accounts have the flexibility and freedom to decide not only what content they wish to view, but whether they wish to continue viewing content related to topics they are currently engaging with.

### Example Methods

Various methods are described with reference to the example system of FIG. 1 for convenience and ease of understanding. However, the methods described are not limited to being performed using the system of FIG. 1 and may be implemented using systems and devices other than those described herein.

The methods described herein represent sequences of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes. In some examples, one or more operations of the method may be omitted entirely. Moreover, the methods described herein can be combined in whole or in part with each other or with other methods.

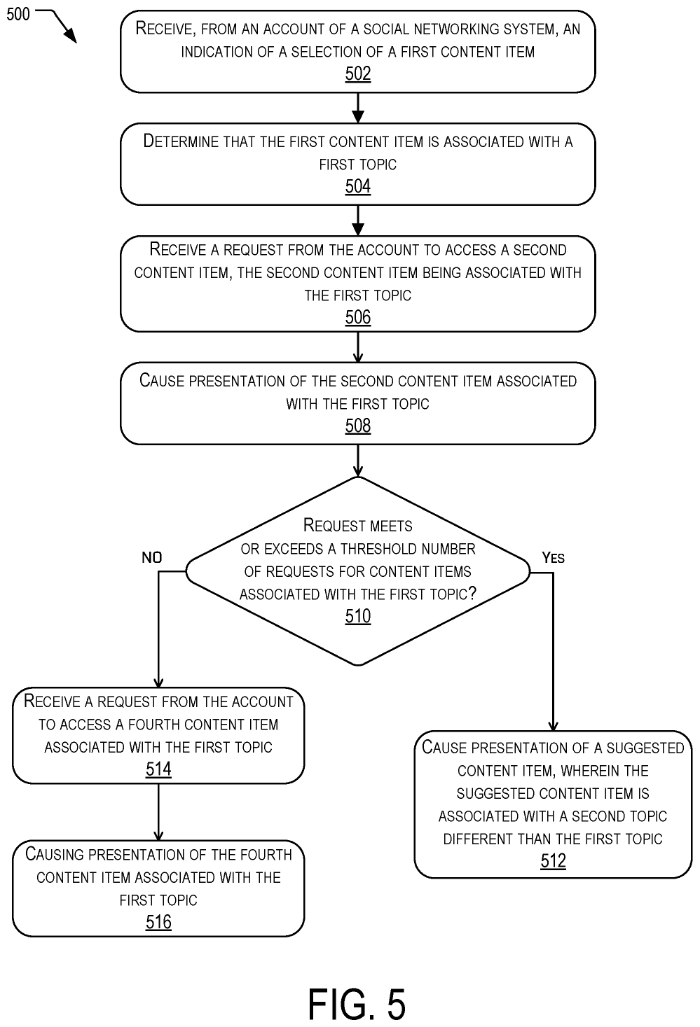

FIG. 5 depicts an example process 500 for providing accounts with suggested content items.

At operation 502, the process 500 may include receiving, from an account of a from an account of a social networking system, an indication of a first content item. The indication may comprise a touch input including a scroll gesture, a swipe gesture, and/or a tap gesture, to name a few non-limiting examples. The first content item may include, for example, at least a portion of a profile post, a story, a reel, and/or a direct message.

At operation 504, the process 500 may include determining, by the social networking system, that the first content item is associated with a first topic. For example, the social networking system may employ a machine-learned model to identify one or more topics associated with the first content item. A topic may be an identifier or a label associated with a content item that may assist the social networking system in organizing and filtering data. For example, a topic may be a broad category including a large portion of content, such as “people,” “products,” or “places,” to name a few non-limiting examples. In other examples, topics may include one or more sub-topics or categories of topics.

At operation 506, the process 500 may include receiving, from the account of the social networking system, a request from the account to access a second content item. The second content item may, in some examples, be associated with the first topic. Based at least in part on receiving, the request to access the second content item, the social networking system may then, in some examples, cause presentation of the second content item associated with the first topic. For example, based at least in part on the request from the account to access the second content item, the social networking system may determine a second content item associated with the first topic.

At operation 508, the process 500 may include causing presentation of the second content item associated with the first topic. For example, based at least in part on the request from the account to access the second content item, the social networking system may determine a second content item associated with the first topic.

At operation 510, the process 500 may include determining that the request meets or exceeds a threshold number of requests for content items associated with the first topic. For example, the social networking system may determine a threshold number of requests (e.g., 1 request, 5 requests, 10 requests, etc.) to access the second content.

At operation 512 (indicated by “YES”), upon determining that the request meets or exceeds the threshold number of requests for content items, the process 500 may include causing presentation of a suggested content item. In some examples, the suggested content item may be associated with a second topic different than the first topic.

At operation 514 (indicated by “NO”), upon determining that the request does not meet or exceed the threshold number of requests for content items, the process 500 may include receiving a request from the account to access a fourth content item. In some examples, the fourth content item may be associated with the first topic, similar to the first content item and the second content item.

At operation 516, the process 500 may include causing presentation, by the social networking system, of the fourth content item associated with the first topic. In this way, the account may continue viewing content associated with the first topic.

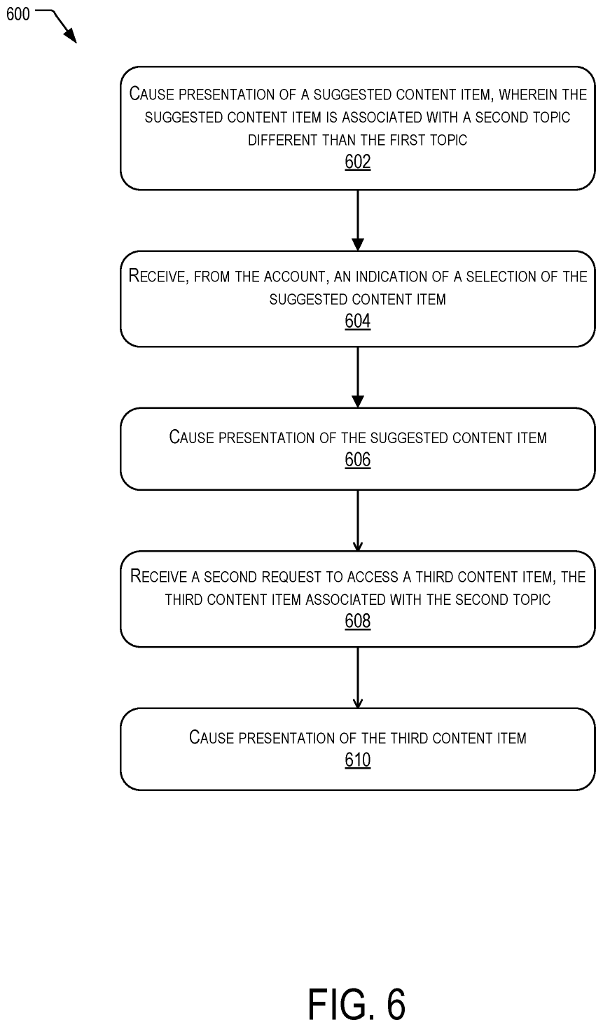

FIG. 6 depicts an example process 600 for providing content associated with a suggested content item.

At operation 602, similar to operation 512, the process 600 may include causing presentation, by the social networking system, of a suggested content item. In some examples, the suggested content item may be associated with a second topic different than the first topic.

At operation 604, the process 600 may include receiving, from the account, an indication of a selection of the suggested content item. Similar to that of receiving the selection of the first content item and receiving the request to access the second content item, the selection of the suggested content item may comprise a touch input including a scroll gesture, a swipe gesture, and/or a tap gesture.

At operation 606, the process 600 may include causing presentation, by the social networking system, of the suggested content item. For example, the suggested content item, as first presented by the social networking system based at least in part on the request to access the second content item meeting or exceeding the threshold number of requests, may be presented by the social networking system as a preview of the suggested content item. In other words, the suggested content item may be displayed as a smaller depiction of the suggested content item, and/or a portion of the suggested content item, for example. Thus, presenting the content item may include presenting a larger and/or complete version of the suggested content item.

At operation 608, the process 600 may include receiving, by the social networking system, a second request to access a third content item. In some examples, the third content item may be associated with the second topic.

At operation 610, the process 600 may include causing presentation, by the social networking system, of the third content item. In this way, the user associated with the account may continue to explore content related to the suggested second topic.

### Example System and Device

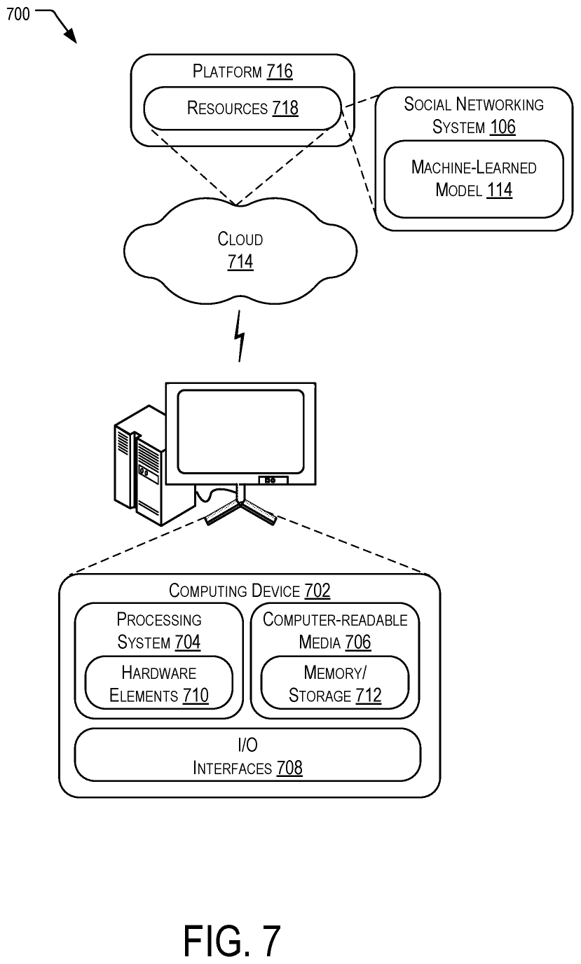

FIG. 7 illustrates an example system generally at 700 that includes an example computing device 702 that is representative of one or more computing systems and/or devices that may implement the various techniques described herein. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interface 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware elements 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 706 is illustrated as including memory/storage component 712. The memory/storage component 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “logic,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on and/or transmitted across some form of computer-readable media. The computer-readable media may include a variety of media that may be accessed by the computing device 702. By way of example, and not limitation, computer-readable media may include “computer-readable storage media” and “computer-readable transmission media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer-readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable transmission media” may refer to a medium that is configured to transmit instructions to the hardware of the computing device 702, such as via a network. Computer-readable transmission media typically may transmit computer-readable instructions, data structures, program modules, or other data in a modulated data signal, such as carrier waves, data signals, or other transport mechanism. Computer-readable transmission media also include any information delivery media. The term “modulated data signal” means a signal that has one or more of its characteristics set or changed in such a manner as to encode information in the signal. By way of example, and not limitation, computer-readable transmission media include wired media such as a wired network or direct-wired connection, and wireless media such as acoustic, radio frequency (RF), infrared, and other wireless media.

As previously described, hardware elements 710 and computer-readable media 706 are representative of modules, programmable device logic and/or device logic implemented in a hardware form that may be employed in some examples to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

The techniques described herein may be supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 may abstract resources and functions to connect the computing device 702 with other computing devices. The platform 716 may also be scalable to provide a corresponding level of scale to encountered demand for the resources 718 that are implemented via the platform 716. Accordingly, in an interconnected device embodiment, implementation of functionality described herein may be distributed throughout multiple devices of the system 700. For example, the functionality may be implemented in part on the computing device 702 as well as via the platform 716 which may represent a cloud computing environment or “cloud” 714.

The example systems and methods of the present disclosure overcome various deficiencies of known prior art devices. Other examples of the present disclosure will be apparent to those skilled in the art from consideration of the specification and practice of the disclosure contained herein. It is intended that the specification and examples be considered as example only, with a true scope and spirit of the present disclosure being indicated by the following claims.

### CONCLUSION

Although the discussion above sets forth example implementations of the described techniques, other architectures may be used to implement the described functionality, and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
receiving, from an account of a social networking system, an indication of a selection of a first content item;
determining that the first content item is associated with a first topic;
receiving a request from the account to access a second content item, the second content item being associated with the first topic;
causing presentation of the second content item associated with the first topic;
determining that the request meets or exceeds a threshold number of requests for content items associated with the first topic; and
causing presentation, based at least in part on the request meeting or exceeding the threshold number of requests, of a suggested content item, wherein the suggested content item is associated with a second topic different than the first topic.

2. The method of claim 1, wherein the request to access the second content item is a first request, the method further comprising:
receiving, from the account of the social networking system, an indication of a selection of the suggested content item;
causing presentation of the suggested content item;
receiving, from the account, a second request to access a third content item, the third content item is associated with the second topic; and
causing presentation, based at least in part on the second request, of the third content item.

3. The method of claim 1, wherein the suggested content item is a first suggested content item, the method further comprising:
causing presentation, based at least in part on determining that the request meets or exceeds the threshold number of requests, of a second suggested content item, wherein the second suggested content item is associated with a third topic different than the first topic and the second topic;
receiving, from the account of the social networking system, an indication of a selection of the second suggested content item;
causing presentation of the second suggested content item;
receiving, from the account, a second request to access a third content item, the third content item being associated with the third topic; and
causing presentation, based at least in part on the second request, of the third content item.

4. The method of claim 1, wherein the request to access the second content item comprises a touch input including at least one of:
a scroll gesture;
a swipe gesture; or
a tap gesture.

5. The method of claim 1, wherein causing presentation of the suggested content item further includes determining the suggested content item, wherein determining the suggested content item is based at least in part on a previous interaction by the account with a content item.

6. The method of claim 5, wherein the previous interaction comprises the account providing an indication of interest.

7. The method of claim 1, wherein the indication is a first indication, the method further comprising:
receiving, from the account, a second indication of lack of interest in the suggested content item;
receiving, from the account, a third indication to access a third content item; and
causing presentation, based at least in part on receiving the third indication and via a device of the account, of a third content item associated with the first topic.

8. The method of claim 1, wherein the first content item comprises at least a portion of a profile post, a story, a reel, or a direct message.

9. A system comprising:
one or more processors; and
computer-readable media storing instructions that, when executed by the one or more processors, cause the system to perform operations comprising:
receiving, from an account of a social networking system, an indication of a selection of a first content item;
determining that the first content item is associated with a first topic;
receiving a request from the account to access a second content item, the second content item being associated with the first topic;
causing presentation of the second content item associated with the first topic;
determining that the request meets or exceeds a threshold number of requests for content items associated with the first topic; and
causing presentation, based at least in part on the request meeting or exceeding the threshold number of requests, of a suggested content item, wherein the suggested content item is associated with a second topic different than the first topic.

10. The system of claim 9, wherein the request to access the second content item is a first request, the operations further comprising:
receiving, from the account of the social networking system, an indication of a selection of the suggested content item;
causing presentation of the suggested content item;
receiving, from the account, a second request to access a third content item, the third content item is associated with the second topic; and
causing presentation, based at least in part on the second request, of the third content item.

11. The system of claim 9, wherein the suggested content item is a first suggested content item, the operations further comprising:
causing presentation, based at least in part on determining that the request meets or exceeds the threshold number of requests, of a second suggested content item, wherein the second suggested content item is associated with a third topic different than the first topic and the second topic;
receiving, from the account of the social networking system, an indication of a selection of the second suggested content item;
causing presentation of the second suggested content item;
receiving, from the account, a second request to access a third content item, the third content item being associated with the third topic; and
causing presentation, based at least in part on the second request, of the third content item.

12. The system of claim 9, wherein the request to access the second content item comprises a touch input including at least one of:
a scroll gesture;
a swipe gesture; or
a tap gesture.

13. The system of claim 9, wherein causing presentation of the suggested content item further includes determining the suggested content item, wherein determining the suggested content item is based at least in part on a previous interaction by the account with a content item.

14. The system of claim 13, wherein the previous interaction comprises the account providing an indication of interest.

15. The system of claim 9, wherein the indication is a first indication, the operations further comprising:
receiving, from the account, a second indication of lack of interest in the suggested content item;
receiving, from the account, a third indication to access a third content item; and
causing presentation, based at least in part on receiving the third indication and via a device of the account, of a third content item associated with the first topic.

16. One or more non-transitory computer-readable media storing instructions that, when executed by one or more processors of a server computing device, cause the server computing device to perform operations comprising:
receiving, from an account of a social networking system, an indication of a selection of a first content item;
determining that the first content item is associated with a first topic;
receiving a request from the account to access a second content item, the second content item being associated with the first topic;
causing presentation of the second content item associated with the first topic;
determining that the request meets or exceeds a threshold number of requests for content items associated with the first topic; and
causing presentation, based at least in part on the request meeting or exceeding the threshold number of requests, of a suggested content item, wherein the suggested content item is associated with a second topic different than the first topic.

17. The one or more non-transitory computer-readable media of claim 16, wherein the first content item comprises at least a portion of a profile post, a story, a reel, or a direct message.

18. The one or more non-transitory computer-readable media of claim 16, wherein the request to access the second content item is a first request, the operations further comprising:
receiving, from the account of the social networking system, an indication of a selection of the suggested content item;
causing presentation of the suggested content item;
receiving, from the account, a second request to access a third content item, the third content item is associated with the second topic; and
causing presentation, based at least in part on the second request, of the third content item.

19. The one or more non-transitory computer-readable media of claim 16, wherein the suggested content item is a first suggested content item, the operations further comprising:
causing presentation, based at least in part on determining that the request meets or exceeds the threshold number of requests, of a second suggested content item, wherein the second suggested content item is associated with a third topic different than the first topic and the second topic;
receiving, from the account of the social networking system, an indication of a selection of the second suggested content item;
causing presentation of the second suggested content item;
receiving, from the account, a second request to access a third content item, the third content item being associated with the third topic; and
causing presentation, based at least in part on the second request, of the third content item.

20. The one or more non-transitory computer-readable media of claim 16, wherein causing presentation of the suggested content item further includes determining the suggested content item, wherein determining the suggested content item is based at least in part on a previous interaction by the account with a content item.
